(19) United States
(12) Patent Application Publication
(10) Pub. No.: US 2026/0342917 A1
(43) Pub. Date: Oct. 29, 2026

(54) RESTRICTED DATA EXCHANGE SYSTEM

(71) Applicant: Bank of America Corporation, Charlotte, NC (US)

(72) Inventors: Kevin Joseph John Bosco, Tamil Nadu (IN); Solarajan Thamilselvam, Tamil Nadu (IN); Ganesan Mohan, Tamil Nadu (IN); James Arunraj Manoharan, Tamil Nadu (IN)

(21) Appl. No.: 19/189,474

(22) Filed: Apr. 25, 2025

(51) Int. Cl. H04M 3/51; H04L 9/06; H04L 51/046; H04L 51/224

(52) U.S. Cl. CPC H04M 3/5191; H04L 9/0643; H04L 51/046; H04L 51/224; H04M 2203/609

(57) ABSTRACT

Restricted data exchange methods include initiating a telephonic communication between a console and a mobile application. Methods include receiving, from the mobile application, a telephonic communication, on the first line of communication. Methods include generating a console token active for a duration of the telephonic communication. Methods include initiating, by transmitting a push notification from the on-line console to the mobile application, a chat communication between the console and the mobile application. Methods include instructing, via the push notification, the mobile application regarding the telephonic communication, and requesting, via the push notification, acceptance of the second line of communication. Methods include validating the metadata payload. Methods include instantiating a secure data exchange session between the console and the mobile application.

### FIELD OF TECHNOLOGY

Aspects of the disclosure relate to electronic data exchange security.

### BACKGROUND OF THE DISCLOSURE

Persons of malicious intent may utilize the organizational structure of an entity to deceptively obtain sensitive information. Such persons of malicious intent may use various techniques to obtain the sensitive information. Such persons of malicious intent may utilize the sensitive information to make illegitimate purchases or for any other fraudulent activities.

Examples of the various techniques may include, such as vishing, smishing, phishing and any other techniques. Another example of one of the various techniques used by persons of malicious intent may be entity employee impersonation. Entity employee impersonation may involve an impersonator initiating a communication with an entity customer, e.g., placing a telephone call to the entity customer, communicating with the entity customer, and requesting and receiving sensitive account information during the communication. The impersonator may exploit the received sensitive information to illegitimately access the entity customer’s account.

It would be desirable to create system that distinguishes, to an entity customer, between an entity employee and an entity employee impersonator in order to restrict data exchange between an entity employee impersonator and a customer.

### SUMMARY OF THE DISCLOSURE

A restricted data exchange system is provided. The restricted data exchange system may serve to distinguish, to an entity customer, between an entity employee and an entity employee impersonator. The restricted data exchange system may prevent the entity customer from providing sensitive information to an entity employee impersonator. The restricted data exchange system may be initiated during, or at the initiation of, a communication between the customer and a purported entity employee.

The restricted data exchange system may include a memory and a processor. The processor may be operable to transmit a push notification to an entity application operating on a mobile device associated with the customer. The push notification may be transmitted upon electronic determination of an entity employee initiating a communication with a customer.

The push notification may form a required part of an entity-customer communication. The push notification may include a push notification payload. The push notification payload may include metadata. The metadata may include an entity employee token, a device registration token and a chat session identifier.

Upon receipt of the push notification at the mobile device, the entity customer may authorize the push notification at the mobile device. Additionally, upon receipt of the push notification at the mobile device, the system may validate the metadata payload. Validating the metadata payload may include validating the entity employee token. The entity employee token may be validated within a banking data domain to determine that the entity employee exists and is a valid employee. Validating the metadata payload may include validating the device registration token. The device registration token may be validated for device authenticity.

Validating the metadata payload may include validating the chat session identifier. The chat session identifier may be maintained throughout the data exchange communication. The data exchange communication may be a telephone communication, short message service (“SMS”) communication, chat communication and/or any other suitable communication. The chat session identifier may maintain the individuality of the data exchange communication.

Upon validation of the payload validation, the customer may accept or reject the notification. The acceptance and/or rejection of the payload validation may be tracked and stored. As such, the acceptance and/or rejection of the payload validation by the customer may be retrievable at a later time.

Upon acceptance of the notification, the customer and the entity employee may be authorized to engage in communication. Upon authorization, a temporary chat session may be generated by the mobile application within the mobile device.

During communications occurring within the temporary chat session, when an entity employee transmits a message to the customer, the message may be divided into three segments. Each segment may be encrypted by SHA-256 algorithm. Each segment may be pushed into a distinct Kafka® topic (there may be three Kafka® topics, or any other suitable number of Kafka® topics, in total). The Kafka® topics may be assigned a specific order for accurate retrieval. Each segment may include the validated payload –i.e., the entity employee token, the device registration token and the chat session identifier.

A Kafka® topic may model and store data. In order to read data from a Kafka® topic, an application programming interface, or command line interface or a web interface may be used.

The mobile application may receive the message in the temporary chat session. Receipt of the message may include consuming the three Kafka® topics in the specified order. Each segment may be validated. The validation may ensure that the payload included in each of the segments has not been compromised. Such validation may involve verification of the payload data, checksum calculations and any other suitable verification. Upon validation, each of the message segments may be decrypted.

There may be advantages associated with dividing the message into three Kafka® topics/segments, encrypting each of the Kafka® topics/segments using a different algorithm, transmitting each Kafka® topic/segment separately from the other Kafka® topics/segments and decrypting each of the Kafka® topics/segments using a different algorithm. One of the advantages may be heightened security measures. Because a person of malicious intent may be required to compromise three encryption schemes as opposed to a single encryption scheme, it may be more difficult for a person of malicious intent to compromise the message.

Upon validation of each of the segments at the mobile application, the segments may be combined. The information included in the combined segments may be displayed on the mobile application. When the customer transmits a message to the entity employee via the mobile application during the temporary chat session, a customer unique token may be generated for the customer. The customer unique token may be valid for the duration of the communication between the customer and the entity employee. The customer unique token may authenticate the customer. As such, messages transmitted to the entity employee may include metadata payload. The metadata payload may include the customer unique token, the mobile registration token and the chat session ID. It should be noted that, prior to transmission, the message may be divided into three segments. Each segment may be encrypted separately and discretely by a different version of a SHA-256 algorithm. Each segment may be pushed into a distinct Kafka® topic (there may be three Kafka® topics, or any other suitable number of Kafka® topics, in total). The Kafka® topics may be assigned a specific order for accurate retrieval. Each segment may include the validated payload –i.e., the customer unique token, the device registration token and the chat session identifier.

The entity employee may receive the message in the temporary chat session. Receipt of the message may include consuming the three Kafka® topics in the specified order and validating each message segment. Upon validation, each message segment may be decrypted separately from the other message segments.

Upon completion of the temporary chat session, the message segments relating to a chat session identifier may be stored in a database in an encrypted manner in three partitions. In the event a request to retrieve the information included in the encrypted segments is received, the segments corresponding to the requested chat session identifier may be retrieved from the database. The segments may be decrypted, and the segments may be combined. The combined segments may be transmitted to the requestor.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows still another illustrative diagram in accordance with principles of the disclosure;

FIG. 4 shows yet another illustrative diagram in accordance with principles of the disclosure;

FIG. 5 shows still another illustrative diagram in accordance with principles of the disclosure;

FIG. 6 shows yet another illustrative diagram in accordance with principles of the disclosure; and

FIG. 7 shows still yet another illustrative diagram in accordance with principles of the disclosure.

### DETAILED DESCRIPTION OF THE DISCLOSURE

Apparatus, systems and methods for restricted data exchange are provided. The system may include an entity employee on-line console and a mobile application. The employee on-line console may operate on a processing device, such as for example, an entity hardware processor. The mobile application may operate on a mobile device.

The entity employee on-line console may include a telephonic interface, a chat interface and/or an entity employee token generator. The telephonic interface may enable telephonic communications between the on-line console and another device. The chat interface may enable chat communications between the on-line console and another device.

The entity employee token generator may be operable to generate an entity employee token. The entity employee token may be active for a duration of a communication. The entity employee token may be customized for the entity employee on-line console. It should be noted that the entity employee token generator may be operable to generate a token for each communication. As such, the entity employee token generator may be operable to generate multiple tokens.

The mobile application may include a mobile registration token, a telephonic interface, a chat interface; and a mobile application token generator. The mobile registration token may be a token that registers the mobile device with the entity. The mobile registration token may be a static registration token.

The telephonic interface may enable telephonic communications between the mobile device and another device. The chat interface may enable chat communications between the mobile device and another device.

The mobile application token generator may be operable to generate a mobile application token. The mobile application token may be active for the duration of the communication. The mobile application token may be customized for the mobile application.

The entity employee on-line console may initiate a telephonic communication with the mobile application via the telephonic interface on the entity employee on-line console and the telephonic interface on the mobile application. The telephonic communication may be instantiated upon acceptance of the telephonic communication at the mobile application.

Upon instantiation of the telephonic communication, the entity employee token generator may generate the entity employee token. The on-line console may transmit a notification of the telephonic communication to the mobile application for approval. The notification may be via a push notification. The notification may preferably not be via the telephonic communication.

Upon approval of the notification by the mobile application, a temporary chat session may be instantiated. The temporary chat session may operate on both the chat interface at the entity employee on-line console and the chat interface at the mobile application.

The entity employee on-line console may generate a message to be transmitted during the temporary chat session from the chat interface at the entity employee on-line console to the chat interface at the mobile application. The entity employee on-line console may separate the message into three segments. The entity employee on-line console may add a metadata payload to each segment. The metadata payload may include the entity employee token, the mobile registration token and a chat session identifier. The chat session identifier may identify the temporary chat session. The chat session identifier may also be used to identify historical chat sessions stored in memory.

The entity employee on-line console may encrypt each of the three segments with a unique encryption algorithm. Each unique encryption algorithm may conform to SHA-256 encryption standards. The entity employee on-line console may load each of the three segments into a distinct Kafka® topic. The entity employee on-line console may transmit three Kafka® topic/segment to the mobile application.

The mobile application may receive three Kafka® topic/segments, validate the three Kafka® topic/segments and bind the three Kafka® topics/segments into a single text. The mobile application may display the single text at the chat interface of the mobile application.

Validation of each Kafka® topic/segment may include validating the payload of the segment by determining that the entity employee token has been generated for the communication. Validation of each Kafka® topic/segment may also include validating that the entity employee token corresponds to an entity employee identifier.

The mobile application may generate a message to be transmitted during the temporary chat session from the chat interface at the mobile application to the chat interface at the entity employee on-line console.

The mobile application may separate the message into three segments. The mobile application may add a metadata payload to each segment. The metadata payload may include the mobile application token, the mobile registration token and a chat session identifier. The chat session identifier may identify the temporary chat session.

The mobile application may encrypt each of the three segments with a unique encryption algorithm. Each unique encryption algorithm may conform to SHA-256 encryption standards. The mobile application may load each of the three segments into a distinct Kafka® topic. The mobile application may transmit three Kafka® topics/segments to the entity employee on-line console.

The entity employee on-line console may receive three Kafka® topics/segments. The entity employee on-line console may validate the three Kafka® topics/segments. The entity employee on-line console may bind the three Kafka® topics/segments into a single text. The entity employee on-line console may display the single text at the chat interface of the entity employee on-line console.

Validation of each Kafka® topic/segment may include validating the payload of the segment by determining that the mobile application token has been generated for the communication. Validation of each Kafka® topic/segment may include validating that the mobile application token corresponds to a mobile application identifier.

It should be noted that the entity employee token may be formatted in a first format, the mobile application token may be formatted in a second format and the first format may be different from the second format.

It should also be noted that the notification may include a payload. The payload may include the entity employee token, the mobile registration token, and a chat session identifier.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

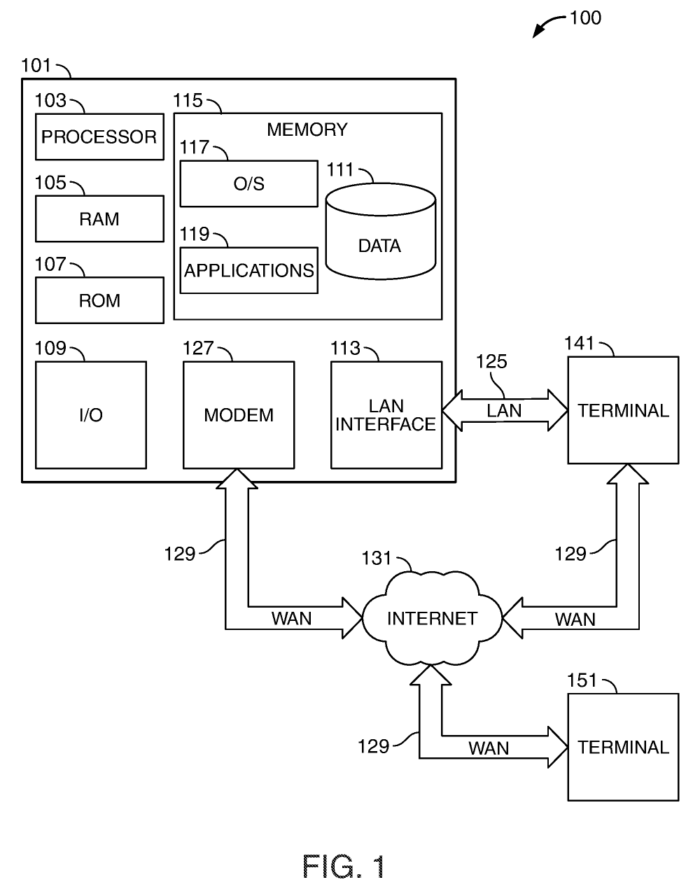

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

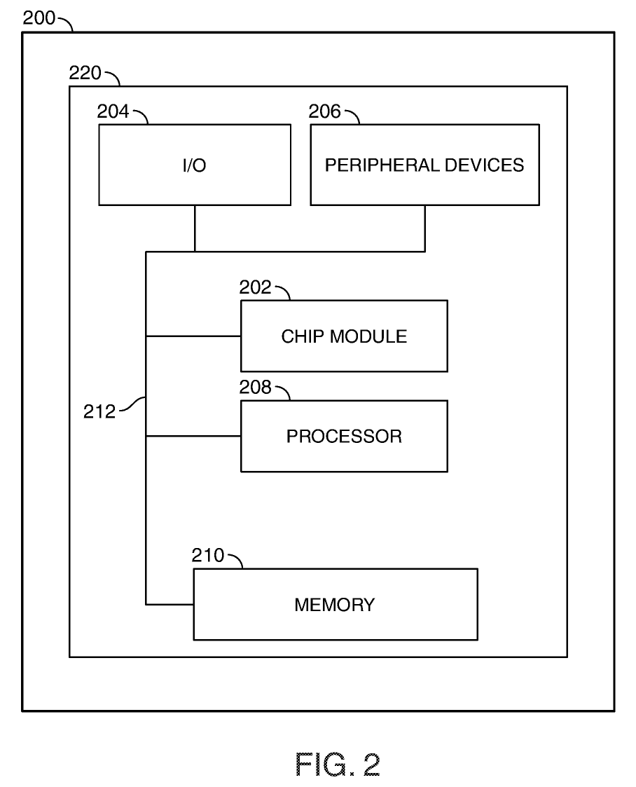

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

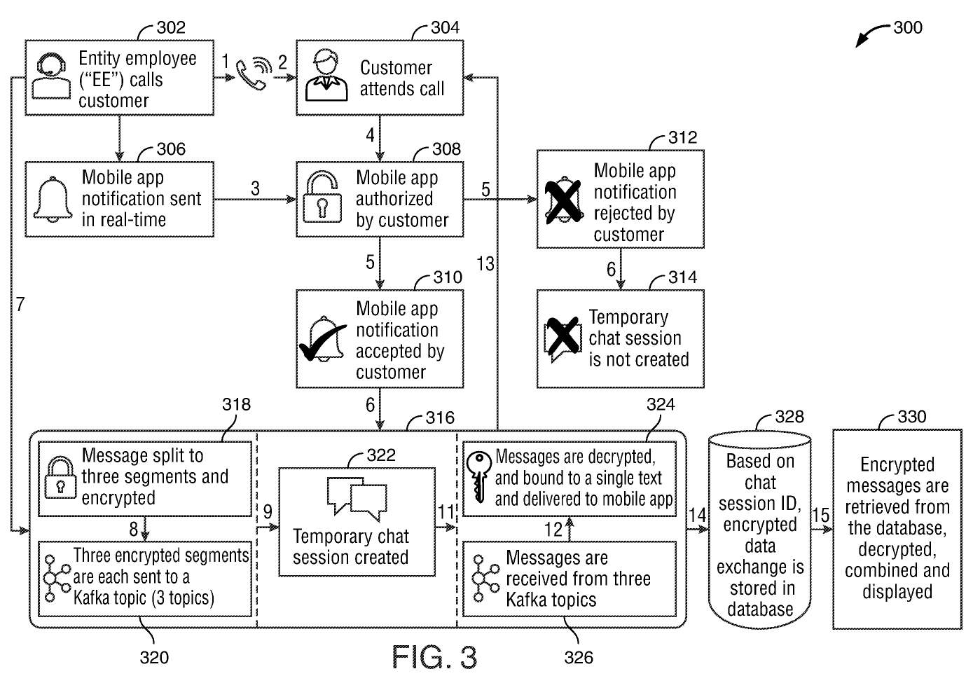

FIG. 3 shows an illustrative diagram 300. An entity employee (“EE”) may initiate a communication with a customer, as shown at 302. The communication may be a telephone communication.

Upon initiation of the telephone communication from the EE to the customer, a second line of communication may be initiated between the EE and the customer. The second line of communication may involve a mobile device. The second line of communication may involve a mobile application notification transmitted from the EE to a mobile device associated with the customer, as shown at 306. It should be noted that the first line of communication (telephone communication) and the second line of communication (mobile application notification) may be initiated and be executed simultaneously.

It should be noted that a mobile application may have been previously installed on the mobile device. In the event that the mobile application is not installed on the mobile device, the push notification may involve instructions for the customer to authorize and install the mobile application.

The customer may attend the call, as shown at 304. The customer may also authorize/accept the mobile application notification, as shown at 308. The mobile application notification may be rejected by the customer, as shown at 312. In the event that the notification is rejected by the customer, a temporary chat session may not be created, as shown at 314.

The mobile application notification may be authorized/accepted by the customer, as shown at 310. In event that the mobile application is authorized/accepted by the customer, a temporary chat session may be created, as shown at 316. Creation of the temporary chat session may involve multiple components, which may be described below.

As indicated by the arrow between 302 and 316, the EE may initiate a secure data exchange between the EE and the customer.

The secure data exchange may involve splitting a message into three segments, as shown at 318. Each of the three segments may be encrypted. Each of the three segments may be loaded into a distinct Kafka® topic. As such, each of the three segments loaded into a distinct Kafka® topic may be transmitted to the customer via the temporary chat session, as shown at 322. The three segments may be received at the customer’s mobile device, as shown at 324. Each of the messages may be validated at the customer's mobile device. Upon validation of the messages at the customer's mobile device, the messages may be decrypted and combined and bound to a single text, or message. The combined message is delivered to the mobile application, as shown at 324.

It should be noted that the messages transmitted over the system may be stored in a database. The messages may be stored in an encrypted format. The messages may be stored in the segmented format as three distinct encrypted Kafka® messages. The messages may each include a metadata payload. The metadata payload may include a chat session identifier. The chat session identifier may be used to identify each of the messages. As such, each of the stored message segments may be identifiable via the chat session identifier.

It the event that the message is retrieved from the database, the encrypted messages may be retrieved from the database based on the chat session identifier, as shown at 330. The retrieved messages may be decrypted, combined and displayed. The combined messages may be displayed on the mobile application of the customer and/or an online banking console for the EE.

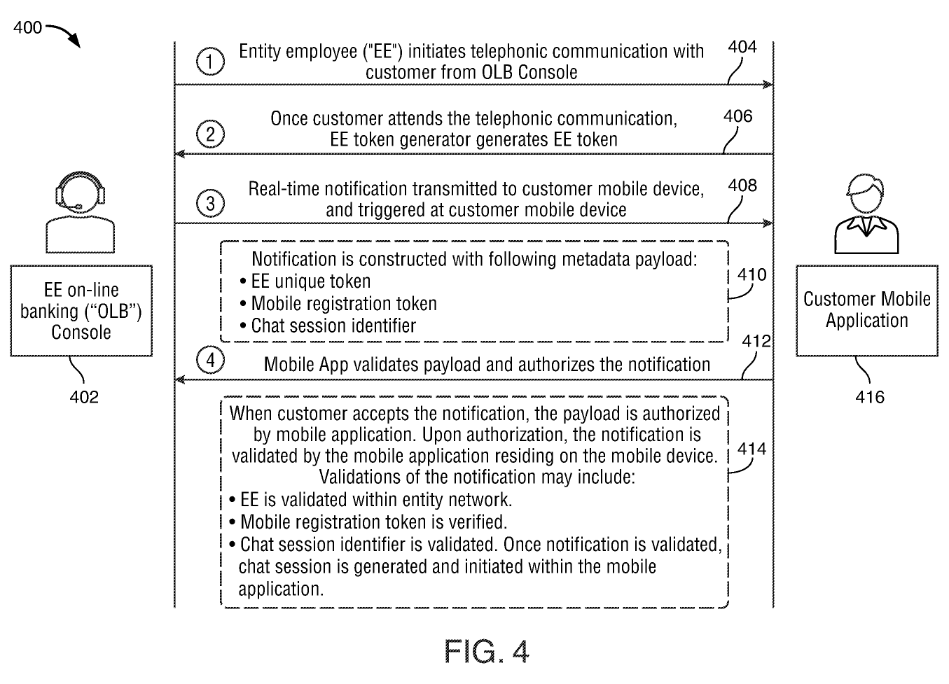

FIG. 4 shows illustrative diagram 400. Illustrative diagram 400 shows an entity employee operating on on-line banking (“OLB”) console 402 may initiate a telephonic communication with a customer operating on mobile application 416, as shown at 404.

Once the customer attends the telephonic communication, an entity employee (“EE”) token generator generates an EE token, as shown at 406. The EE token verifies the EE within a banking data domain to establish that the EE exists and is a valid employee. The EE token may be unique and valid for the lifetime of the communication between the EE and the customer. Upon completion of the communication, the EE token may expire and no longer be valid, or able to validate the EE within a communication.

A real-time notification may be transmitted to customer mobile device. The real-time notification may be triggered at the customer mobile device, as shown at 408.

It should be noted that the notification may be constructed with a metadata payload, as shown at 410. The metadata payload may include the EE token, a mobile registration token and a chat session identifier. The EE token may validate the EE. The mobile registration token may verify the mobile device and the connection between the mobile device and the customer. It should be noted that the mobile registration token may be a continuous token. As such, the mobile registration token may be valid for multiple communications. The chat session identifier may be an identifier that identifies the communication between the EE and the customer. The chat session identifier may be applicable for a single communication between the EE and the customer. As such, upon termination of the communication, the chat session identifier may no longer be used to identify a current communication, rather the chat session communication may be used to label the historic communication.

Upon receipt of the notification at the customer, the mobile application may validate the payload. Upon validation, the mobile application may authorize the notification. It should be noted that the mobile application may display a selectable option to accept or reject the notification. The customer may select the selectable option to accept the notification, as shown at 412.

When the customer accepts the notification, the mobile application may be authorized by the customer/user. Upon authorization, the notification may be validated by the mobile application residing on the mobile device. The validation of the notification may include validating the metadata payload. Validation of the notification may include validating that the EE is active within the entity network. Validation of the notification may include verifying the validity of the mobile registration token. Validation of the notification may include validating the session identifier. Validation of the notification may include validating the chat session identifier. Upon validation of the notification, a chat session is generated and initiated within the mobile application.

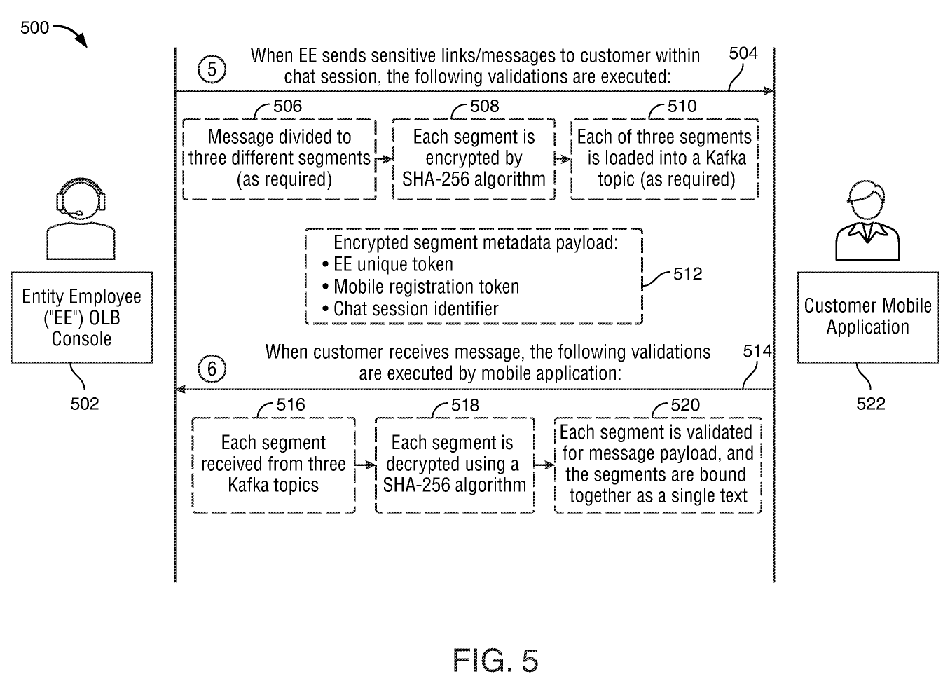

FIG. 5 shows illustrative diagram 500. Illustrative diagram 500 involves transmitting sensitive data from an EE at an EE OLB console (502) to a customer mobile application (522).

An EE sends sensitive links/messages to a customer within a chat session, as shown at 504. When the EE sends the sensitive links/messages, validations shown at 506, 508 and 510 are executed. The sensitive links/messages may be divided into three different segments, as shown at 506.

Each segment may be encrypted, as shown at 508. A SHA-256 algorithm may be used to encrypt each segment. Each segment may be encrypted with a different algorithm. The encrypted segment may include a metadata payload. The metadata payload may include an EE unique token, a mobile registration token and a chat session identifier, as shown at 512. Each of the three segments may be loaded into a Kafka® topic, as shown at 510.

When the customer receives message, the message is validated by the mobile application, as shown at 514. The validations may be shown at 516, 518 and 520. The validations may include receiving from the three Kafka® topics, shown at 516. Each segment may be decrypted using a SHA-256 algorithm, shown at 518. Each segment may be validated for the message payload, as shown at 520. At times, the decryption may be executed prior to the validation, other times, the decryption may be executed after the validation. The validated, decrypted segments may be bound together as a single text, as shown at 520. The single text may be displayed on the mobile application 522.

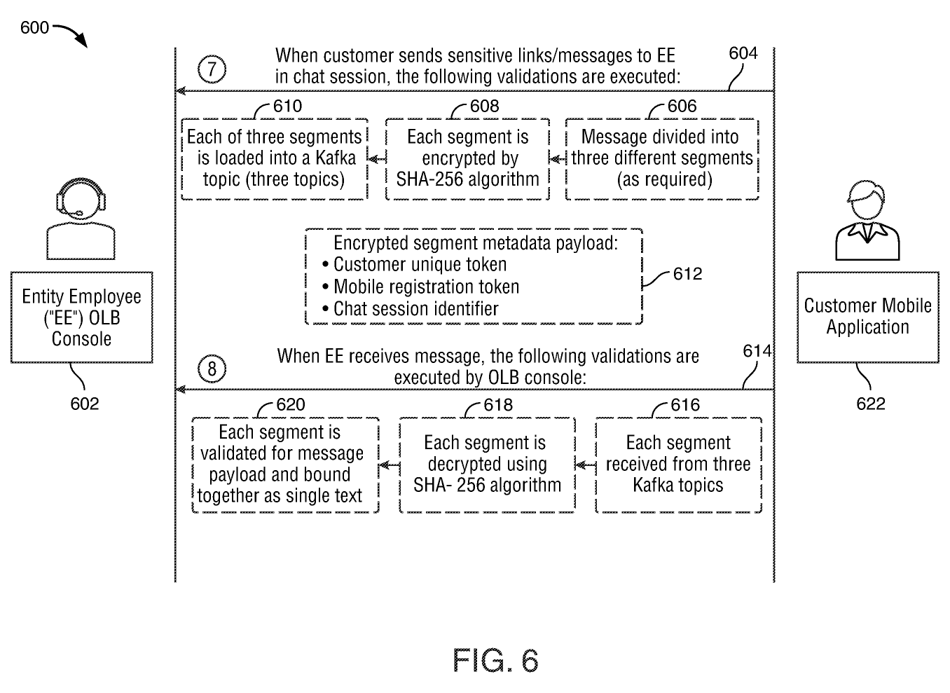

FIG. 6 shows illustrative diagram 600. Illustrative diagram 600 involves a customer operating a customer mobile application 622 transmitting sensitive links/messages to EE operating an EE OLB console 602 in a chat session. When a customer transmits sensitive links/messages to EE in chat session, validations shown at 606, 608 and 610 may be executed. The message may be divided into three different segments, as shown at 606.

Each segment may be encrypted by a SHA-256 algorithm, as shown at 608. The encrypted segment may include a metadata payload, as shown at 612.

The metadata payload may include a customer unique token, a mobile registration token and a chat session identifier. It should be noted that the customer unique token may be a token generated by a customer token generator. The customer unique token may authenticate the customer to EE. The customer unique token may be valid for the lifetime of the communication session between the customer and the EE.

Each of the three segments is loaded into a Kafka® topic, as shown at 610. There may be a total of three topics (one corresponding to each segment).

When EE receives a message, validations may be executed by the OLB console, as shown at 614. The validations may be shown at 616, 618 and 620. The validations may include receiving each segment from the three Kafka® topics, as shown at 616. The validations may include decrypting each segment using SHA-256 algorithm, as shown at 618. The validations may include validating each segment for the message payload. At times, the decryption may be executed prior to the validation, other times, the decryption may be executed after the validation. The validated, decrypted segments may be combined and bound as a single text, as shown at 620. The single text may be displayed on the EE OLB console 602.

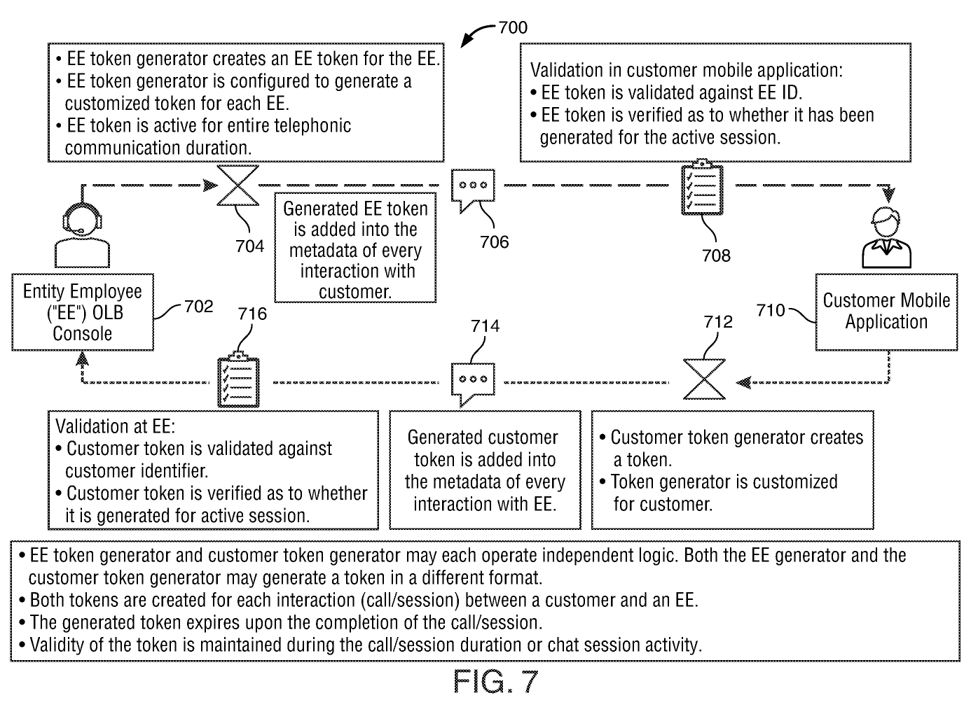

FIG. 7 shows illustrative diagram 700. Communications between an EE operating EE OLB console 702 and a customer operating customer mobile application 710 may be shown.

EE OLB console 702 may initiate a communication with customer mobile application 710. EE token generator 704 may generate an EE token for the EE. EE token generator 704 may be configured to generate a customized token for each EE. The token generated by EE token generator 704 may be active for the entire communication duration.

Data exchanger 706, located at EE OLB console 702, may add the generated EE token into the metadata of every interaction with the customer.

Data validator 708 located at customer mobile application 710 may execute validations within customer mobile application. Data validator 708 may validate the EE token against an EE identifier. Data validator 708 may validate the EE token as to whether it has been generated for the active session.

Customer token generator 712 may generate a token for customer mobile application 710. Tokens generated by token generator 712 may be customized for customer mobile application 710.

Data exchanger 714, located at customer mobile application 710, may add the generated customer token into the metadata of every interaction with the EE.

Data validator 716 located at EE may validate the customer token against a customer identifier. Data validator 718 may also verify the customer token as to whether it has been generated for the active session.

It should be noted that EE token generator 704 and customer token generator 712 may each operate independent logic. Both EE token generator 704 and customer token generator 712 may generate a token in a different format. The EE token and the customer token may be created for each interaction –e.g., call or session– between a customer and an EE. The generated token may expire upon the completion of the call or session. The validity of the token may be maintained during the call/session duration or chat session activity.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

Thus, methods and apparatus for a restricted data exchange system are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A restricted data exchange system, the system comprising:
an entity employee on-line console, said entity employee on-line console comprising:
a telephonic interface;
a chat interface; and
an entity employee token generator operable to generate an entity employee token, said entity employee token:
active for a duration of a communication;
customized for the entity employee on-line console;
a mobile application, said mobile application comprising:
a mobile registration token;
a telephonic interface;
a chat interface; and
a mobile application token generator operable to generate a mobile application token, said mobile application token:
active for the duration of the communication; and
customized for the mobile application;
wherein:
the entity employee on-line console initiates a telephonic communication with the mobile application via the telephonic interface on the entity employee on-line console and the telephonic interface on the mobile application;
the telephonic communication is instantiated upon acceptance of the telephonic communication at the mobile application, said telephonic communication being the communication;
upon instantiation of the telephonic communication:
the entity employee token generator generates the entity employee token;
the on-line console transmits a notification to the mobile application for approval;
upon approval of the notification by the mobile application, a temporary chat session is instantiated, the temporary chat session operating on both the chat interface at the entity employee on-line console and the chat interface at the mobile application;
the entity employee on-line console:
generates a message to be transmitted during the temporary chat session from the chat interface at the entity employee on-line console to the chat interface at the mobile application;
separates the message into three segments;
adds a metadata payload to each segment, said metadata payload comprising the entity employee token, the mobile registration token and a chat session identifier, said chat session identifier identifying the temporary chat session;
encrypts each of the three segments with a unique encryption algorithm;
loads each of the three segments into a distinct Kafka® topic;
transmits three Kafka® topic/segment to the mobile application;
the mobile application:
receives three Kafka® topic/segments;
validates three Kafka® topic/segments; and
binds the three Kafka® topics/segments into a single text; and
displays the single text at the chat interface of the mobile application.

2. The system of claim 1 wherein:
the entity employee token is formatted in a first format;
the mobile application token is formatted in a second format; and
the first format is different from the second format.

3. The system of claim 1 wherein the mobile registration token is a static registration token.

4. The system of claim 1 wherein:
the notification comprises a payload; and
the payload comprises:
the entity employee token,
the mobile registration token; and
a chat session identifier.

5. The system of claim 1 wherein validation of each Kafka® topic/segment comprises:
validating the payload of the segment by determining that the entity employee token has been generated for the communication; and
validating the entity employee token corresponds to an entity employee identifier.

6. The system of claim 1 wherein each unique encryption algorithm conforms to SHA-256 encryption.

7. The system of claim 1 wherein the chat session identifier is used to identify historical chat sessions stored in memory.

8. A restricted data exchange system, the system comprising:
an entity employee on-line console, said entity employee on-line console comprising:
a telephonic interface;
a chat interface; and
an entity employee token generator operable to generate an entity employee token, said entity employee token:
active for a duration of a communication;
customized for the entity employee on-line console;
a mobile application, said mobile application comprising:
a mobile registration token;
a telephonic interface;
a chat interface; and
a mobile application token generator operable to generate a mobile application token, said mobile application token:
active for the duration of the communication; and
customized for the mobile application;
wherein:
the entity employee on-line console initiates a telephonic communication with the mobile application via the telephonic interface on the entity employee on-line console and the telephonic interface on the mobile application;
the telephonic communication is instantiated upon acceptance of the telephonic communication at the mobile application, said telephonic communication being the communication;
upon instantiation of the telephonic communication:
the entity employee token generator generates the entity employee token;
the on-line console transmits a notification to the mobile application for approval;
upon approval of the notification by the mobile application, a temporary chat session is instantiated, the temporary chat session operating on both the chat interface at the entity employee on-line console and the chat interface at the mobile application;
the mobile application:
generates a message to be transmitted during the temporary chat session from the chat interface at the mobile application to the chat interface at the entity employee on-line console;
separates the message into three segments;
adds a metadata payload to each segment, said metadata payload comprising the mobile application token, the mobile registration token and a chat session identifier, said chat session identifier identifying the temporary chat session;
encrypts each of the three segments with a unique encryption algorithm;
loads each of the three segments into a distinct Kafka® topic;
transmits three Kafka® topic/segments to the entity employee on-line console;
the entity employee on-line console:
receives three Kafka® topic/segments;
validates the three Kafka® topic/segments; and
binds the three Kafka® topics/segments into a single text; and
displays the single text at the chat interface of the entity employee on-line console.

9. The system of claim 8 wherein:
the entity employee token is formatted in a first format;
the mobile application token is formatted in a second format; and
the first format is different from the second format.

10. The system of claim 8 wherein the mobile registration token is a static registration token.

11. The system of claim 8 wherein:
the notification comprises a payload; and
the payload comprises:
the entity employee token,
the mobile registration token; and
a chat session identifier.

12. The system of claim 8 wherein validation of each Kafka® topic/segment comprises:
validating the payload of the segment by determining that the mobile application token has been generated for the communication; and
validating the mobile application token corresponds to an mobile application identifier.

13. The system of claim 8 wherein each unique encryption algorithm conforms to SHA-256 encryption.

14. The system of claim 8 wherein the chat session identifier is used to identify historical chat sessions stored in memory.

15. A method for operating a restricted data exchange system, the method comprising:
initiating a first line of communication between an on-line console and a mobile application executing on a mobile device, said first line of communication being a telephonic communication between the on-line console and the mobile device;
receiving, from the mobile application, a communication, on the first line of communication;
in response to receiving the communication on the first line of communication from the mobile application, generating, at a token generator located at the on-line console, a console token, said console token identifying an operator of the on-line console, said console token active for as long as the first line of communication endures;
initiating a second line of communication between the on-line console and the mobile application, the second line of communication initiated by transmitting a push notification from the on-line console to the mobile application, said push notification comprising a metadata payload, said metadata payload comprising:
the console token;
a mobile registration token identifying the mobile application; and
a chat session identifier identifying an active session of the second line of communication;
instructing, via the push notification, the mobile application regarding the first line of communication; and
requesting, via the push notification, acceptance of the second line of communication;
validating, at the mobile application, the metadata payload;
receiving, from the mobile application, acceptance of the second line of communication;
instantiating a secure data exchange session between the on-line console and the mobile device.

16. The method of claim 15 wherein instantiating the secure data exchange between the on-line console and the mobile device comprises:
at the transmitter
dividing transmitted data into three different segments;
encrypting each of the three different segments using SHA-256 algorithm;
load each segment into a Kafka® topic;
at the receiver:
each segment is received from three different Kafka® topics;
each segment is decrypted by the SHA-256 algorithm;
each segment is validated for the metadata payload and bound as a single text; and
the single text is displayed on a output device associated with the receiver.

17. The method of claim 16 wherein the transmitter is the on-line console and the receiver is the mobile application.

18. The method of claim 16 wherein the receiver is the on-line console and the transmitter is the mobile application.

19. The method of claim 15 wherein the first line of communication is a telephonic communication.
